(19) United States
(12) Patent Application Publication
(10) Pub. No.: US 2010/0247225 A1
(43) Pub. Date: Sep. 30, 2010

(54) COSMETIC APPLYING DEVICE

(76) Inventor: Jun ZHANG, Sijhih City (TW)

Correspondence Address: SINORICA, LLC, 2275 Research Blvd., Suite 500, ROCKVILLE, MD, 20850, US

(21) Appl. No.: 12/413,618

(22) Filed: Mar. 30, 2009

(51) Int. Cl. B05C 11/00

(52) U.S. Cl. 401/266

(57) ABSTRACT

A cosmetic applying device includes a hollow restriction tube and an applying piece having a passage defined therethrough is inserted in the restriction tube. An end of the applying piece extends from an end of the restriction tube. A hollow feeding part is connected to the restriction tube and includes a feeding tube which is inserted into the passage of the applying piece. A soft tube is connected to the feeding part and fluid cosmetic material is received in the soft tube. By squeezing the soft tube, the fluid cosmetic material flows into the applying piece and is applied to the user's body.

### FIELD OF THE INVENTION

The present invention relates to a cosmetic applying device including a soft tube with an applying head which is easily replaced and cleaned.

### BACKGROUND OF THE INVENTION

A conventional way to apply fluid cosmetic material is to spread the fluid cosmetic material on the user's hand or a puff and then apply the fluid cosmetic material to the user's face. However, the conventional way is obviously not satisfied because the hands' temperature affects the fluid cosmetic material and after the applying, the hands need to be washed. Often, the fluid cosmetic material may be contaminated. If the user wants to use with a puff, he or she has to prepare the puff in advance and the fluid cosmetic material is usually attached to the user's hand during using the puff.

The present invention intends to provide an applying head of a cosmetic applying device wherein the applying head includes a restriction tube and an applying piece made of high density foam is connected to the restriction tube, a feeding part is connected to the restriction tube. The applying piece can be easily replaced and cleaned.

### SUMMARY OF THE INVENTION

The present invention relates to a cosmetic applying device which comprises a hollow restriction tube including a shoulder extending inward from an inner periphery thereof and a first connection portion is formed to a first end of the hollow restriction tube. An applying piece has a passage defined therethrough and an engaging portion extends from an outer periphery of the applying piece. The applying piece extends through the restriction tube and the engaging portion is engaged with the shoulder of the restriction tube. A first end of the applying piece extends from a second end of the restriction tube. A hollow feeding part includes a feeding tube extending from a first end thereof and a flange extending radially outward from an outer periphery of the feeding part. The feeding tube is inserted into the passage of the applying piece. A second connection portion is formed to the feeding part so as to be connected to the first connection portion. A second end of the applying piece contacts the flange of the feeding part.

The primary object of the present invention is to provide an applying head for a cosmetic applying device, wherein the applying head has an applying piece made of high density foam which can be easily replaced and cleaned.

Another object of the present invention is to provide an applying head for a cosmetic applying device, wherein the user's hand does not need to contact the fluid cosmetic material during using the cosmetic applying device.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the applying head of the cosmetic applying device of the present invention;

FIG. 2 is an exploded view to show the applying head of the cosmetic applying device of the present invention;

FIG. 3 is another exploded view to show the applying head of the cosmetic applying device of the present invention;

FIG. 4 is a cross sectional view of the applying head of the cosmetic applying device of the present invention;

FIG. 5 is a cross sectional view of the applying piece of the present invention;

FIG. 6 is another embodiment of the cross sectional view of the applying piece of the present invention;

FIG. 7 shows that the applying head of the cosmetic applying device of the present invention is connected with a soft tube, and

FIG. 8 shows that the applying head of the cosmetic applying device of the present invention is connected with a rotatable shank.

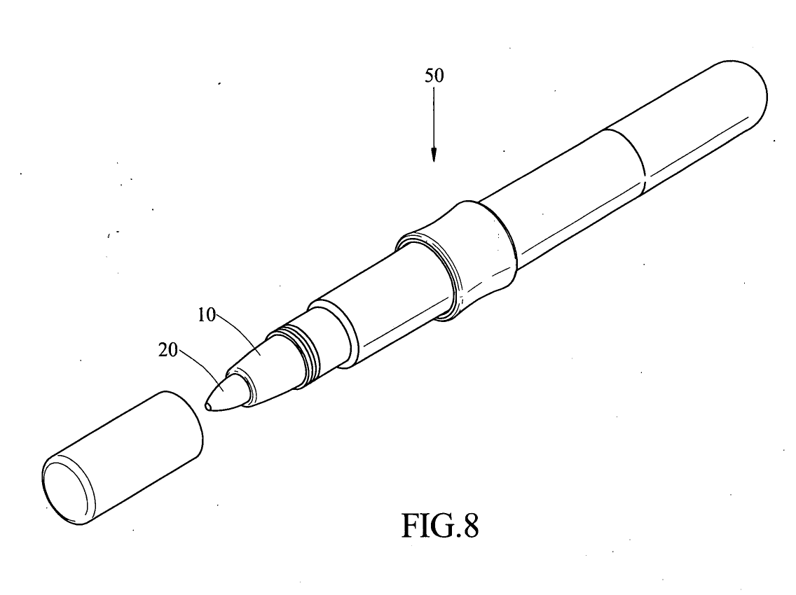

### DETAILED DESCRIPTION OF THE PREFERRED EMBODIMENT

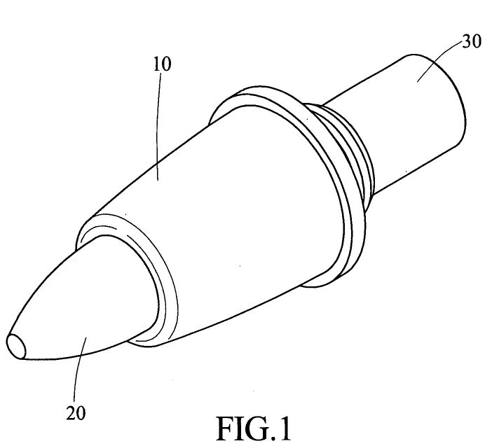

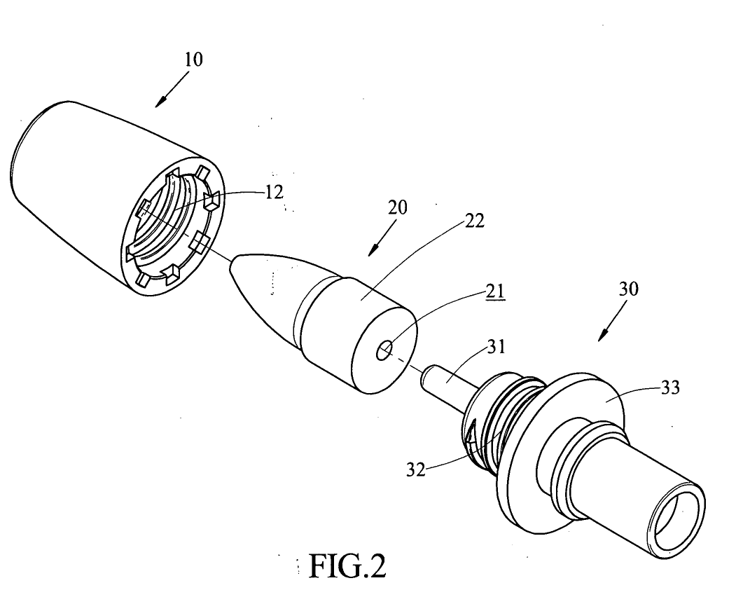

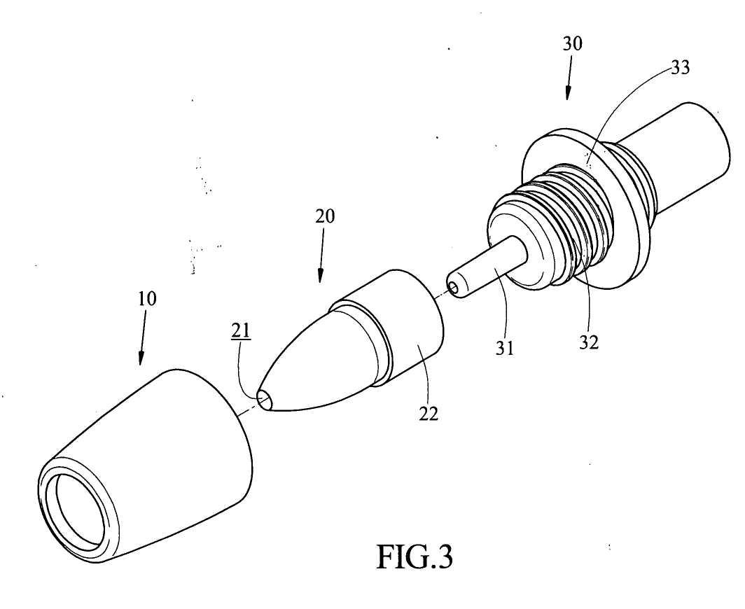

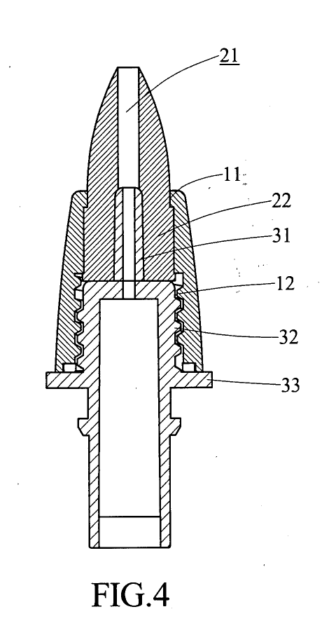

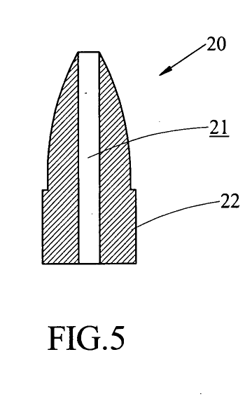

Referring to FIGS. 1 to 5, the applying head of a cosmetic applying device of the present invention comprises a hollow restriction tube 10 which includes two open ends and a shoulder 11 extends inward from an inner periphery thereof. A first connection portion 12 is formed to a first end of the hollow restriction tube 10.

An applying piece 20 is made of high density foam and has a passage 21 defined therethrough. An engaging portion 22 extends from an outer periphery of the applying piece 20. The applying piece 20 extends through the restriction tube 10 and the engaging portion 22 is engaged with the shoulder 11 of the restriction tube 10. A first end of the applying piece 20 extends from a second end of the restriction tube 10.

A hollow feeding part 30 includes a feeding tube 31 extending from a first end thereof and a flange 33 extends radially outward from an outer periphery of the feeding part 30. The feeding tube 31 communicates with an interior and an open end of the feeding part 30. The feeding tube 31 is inserted into the passage 21 of the applying piece 20. A second connection portion 32 is formed to the feeding part 30 so as to be threadedly connected to the first connection portion 12. A second end of the applying piece 20 contacts the flange 33 of the feeding part 30 so as to position the applying piece 20.

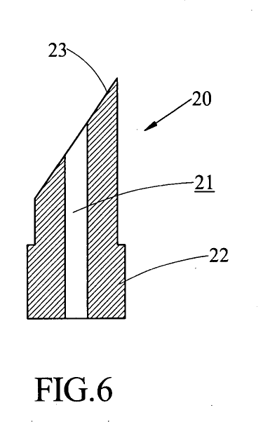

In this embodiment, the first end of the applying piece 20 is a tapered end and any known material can be used. The applying piece 20 may have another form such as an inclined surface defined in the first end of the applying piece 20 as shown in FIG. 6.

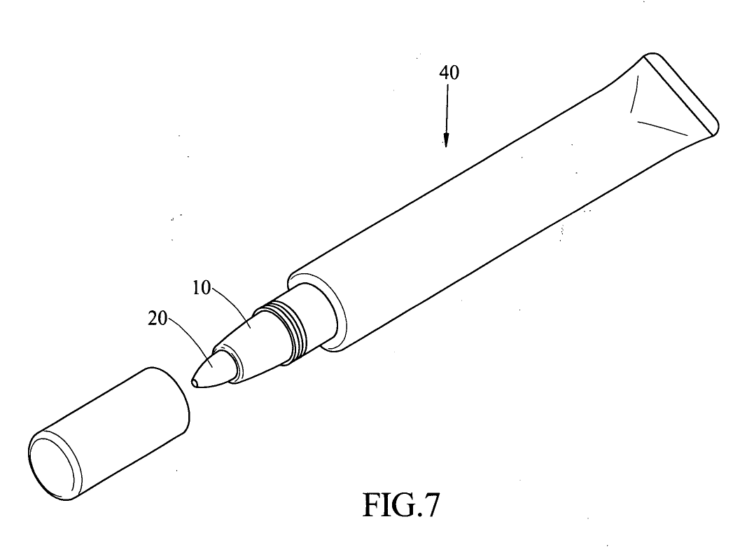

As shown in FIG. 7, when using the applying head, a soft tube 40 is connected to the second end of the feeding part 30. Fluid cosmetic material is received in the soft tube 40 so that when the user squeezes the soft tube 40, the fluid cosmetic material flows through the passage 21 of the applying piece 20 and can be applied to the user's face for example.

The cosmetic applying device can also to have two applying heads on two ends of a rotatable shank 50 and the two feeding parts 30 are connected to the two ends of the rotatable shank 50 by a proper mechanism which is known to person in the art such that the user can rotate the rotatable shank 50 to extend the applying head.

The applying piece 20 can be easily replaced and cleaned, and the fluid cosmetic material does not attach to the user's hand during operation of the cosmetic applying device. The size of the applying piece 20 can be varied according to needs so as to meet different requirements of use.

While we have shown and described the embodiment in accordance with the present invention, it should be clear to those skilled in the art that further embodiments may be made without departing from the scope of the present invention.

What is claimed is:

1. A cosmetic applying device comprising:
a hollow restriction tube including a shoulder extending inward from an inner periphery thereof, a first connection portion formed to a first end of the hollow restriction tube;
an applying piece having a passage defined therethrough and an engaging portion extending from an outer periphery of the applying piece, the applying piece extending through the restriction tube and the engaging portion being engaged with the shoulder of the restriction tube, a first end of the applying piece extending from a second end of the restriction tube, and
a hollow feeding part including a feeding tube extending from a first end thereof and a flange extending radially outward from an outer periphery of the feeding part, the feeding tube communicating with an interior and an open end of the feeding part and inserted into the passage of the applying piece, a second connection portion formed to the feeding part so as to be connected to the first connection portion, a second end of the applying piece contacting the flange of the feeding part.

2. The device as claimed in claim 1, wherein the first end of the applying piece is a tapered end.

3. The device as claimed in claim 1, wherein the first end of the applying piece includes an inclined surface.

4. The device as claimed in claim 1, wherein the first connection portion is threadedly connected to the second connection portion.

5. The device as claimed in claim 1 further comprising a soft tube connected to the feeding part.

6. The device as claimed in claim 1 further comprising a rotatable shank connected to the feeding part.

7. The device as claimed in claim 1, wherein the applying piece is made of high density foam.
